(19) United States
(12) Patent Application Publication
(10) Pub. No.: US 2024/0424814 A1
(43) Pub. Date: Dec. 26, 2024

(54) IMAGE FORMING APPARATUS THAT DESIGNATES SHEET SUPPLY DEVICE FOR SUPPLYING RECORDING SHEET FOR ADJUSTMENT OPERATION

(71) Applicant: KYOCERA Document Solutions Inc., Osaka (JP)

(72) Inventors: Shinji NAKATSUKA, Osaka (JP); Daiki SONE, Osaka (JP)

(73) Assignee: KYOCERA Document Solutions Inc., Osaka (JP)

(21) Appl. No.: 18/745,900

(22) Filed: Jun. 17, 2024

(30) Foreign Application Priority Data
Jun. 23, 2023 (JP) 2023-103590

(51) Int. Cl. B41J 13/00; B41J 13/10; G03G 15/00

(52) U.S. Cl. CPC B41J 13/0018; B41J 13/103; G03G 15/5016; G03G 15/5095; G03G 15/6508

(57) ABSTRACT

An image forming operation includes a plurality of sheet supply devices, an image forming device, an operation device that receives an input of an instruction designating one of the plurality of sheet supply devices, as a supply source of a recording sheet for an adjustment operation, and a controller that decides whether the sheet supply device is to be used as the supply source of the recording sheet for the adjustment operation, with respect to each of the sheet supply devices, according to the instruction inputted to the operation device. When causing the image forming device to execute the adjustment operation, the controller causes the sheet supply device, designated as the supply source of the recording sheet for the adjustment operation, to supply the recording sheet to the image forming device.

### INCORPORATION BY REFERENCE

This application claims priority to Japanese Patent Application No. 2023-103590 filed on Jun. 23, 2023, the entire contents of which are incorporated by reference herein.

### BACKGROUND

The present disclosure relates to an image forming apparatus that forms an image on a recording sheet delivered from a sheet supply device, on the basis of print data, or performs an adjustment operation including an image forming operation for the purpose of adjustment, on the recording sheet. In particular, the present disclosure relates to a technique to designate the sheet supply device that supplies the recording sheet for the adjustment operation.

The image forming apparatuses can be typically classified into an electrophotographic printer that applies toner onto a recording sheet, thereby forming an image thereon, and an ink jet printer that ejects ink onto the recording sheet, thereby forming an image thereon. In the case of the electrophotography, an adjustment operation, including forming a predetermined pattern on the recording sheet, is performed for adjustment of the density of the image. In the case of the ink jet printing, an adjustment operation, including spitting the ink in an ink head onto the recording sheet, is performed to maintain the performance level of the ink head.

Some of existing recording apparatuses include a plurality of sheet cassettes, in which different recording media are respectively stored. In such a recording apparatus, the recording medium on which a test pattern is to be recorded is decided on the basis of a priority order of the size of the recording medium, and of the type thereof. Then the cassette containing the recording medium that has been decided is selected, and the test pattern is recorded on the recording medium supplied from the selected cassette.

### SUMMARY

The disclosure proposes further improvement of the foregoing techniques.

In an aspect, the disclosure provides an image forming apparatus including a plurality of sheet supply devices, an image forming device, an operation device, and a control device. The plurality of sheet supply devices each supply a recording sheet. The image forming device executes an image forming operation on a basis of print data, on the recording sheet supplied from one of the sheet supply devices, or an adjustment operation including a prespecified image forming operation for adjustment. The operation device receives an instruction, inputted by a user and designating one of the plurality of sheet supply devices, as a supply source of the recording sheet for the adjustment operation. The control device includes a processor, and acts as a controller that decides, when the processor executes a control program, whether the sheet supply device is to be used as the supply source of the recording sheet for the adjustment operation, with respect to each of the sheet supply devices, according to the instruction inputted to the operation device. When causing the image forming device to execute the adjustment operation, the controller causes the sheet supply device, designated as the supply source of the recording sheet for the adjustment operation, to supply the recording sheet to the image forming device.

### BRIEF DESCRIPTION OF THE DRAWINGS

FIG. 1 is a cross-sectional view showing an image forming apparatus according to a first embodiment of the disclosure;

FIG. 2 is a block diagram showing an essential internal configuration of the image forming apparatus;

FIG. 3 is a flowchart showing a process of designating a sheet cassette as a supply source of a recording sheet for adjustment operation, or as a supply source of the recording sheet for executing a print job;

FIG. 4 is a schematic drawing showing an initial screen displayed on a display device of the image forming apparatus;

FIG. 5 is a schematic drawing showing a sheet selection screen displayed on the display device of the image forming apparatus;

FIG. 6A is a schematic drawing showing a sheet designation window for adjustment operation, displayed on the display device of the image forming apparatus;

FIG. 6B is a schematic drawing showing a message urging the user to change the type of adjustment operation, displayed in the sheet designation window for adjustment operation;

FIG. 7 is a schematic drawing showing a message notifying that the sheet cassette displayed on the display device of the image forming apparatus is already selected as the supply source of the recording sheet for adjustment operation;

FIG. 8 is a schematic drawing showing a sheet designation window for the print job, displayed on the display device of the image forming apparatus;

FIG. 9 is a data table containing property information of each of the sheet cassettes;

FIG. 10A is a flowchart showing a process of selecting one of the sheet cassettes, and causing the selected sheet cassette to supply the recording sheet;

FIG. 10B is a flowchart showing a process that follows the process of FIG. 10A;

FIG. 11 is a schematic drawing showing a first sheet repurpose screen, displayed on the display device of the image forming apparatus;

FIG. 12 is a schematic drawing showing a second sheet repurpose screen, displayed on the display device of the image forming apparatus; and

FIG. 13 is a cross-sectional view showing an image forming apparatus according to a second embodiment of the disclosure.

### DETAILED DESCRIPTION

Hereafter, an image forming apparatus according to some embodiments of the disclosure will be described, with reference to the drawings.

### First Embodiment

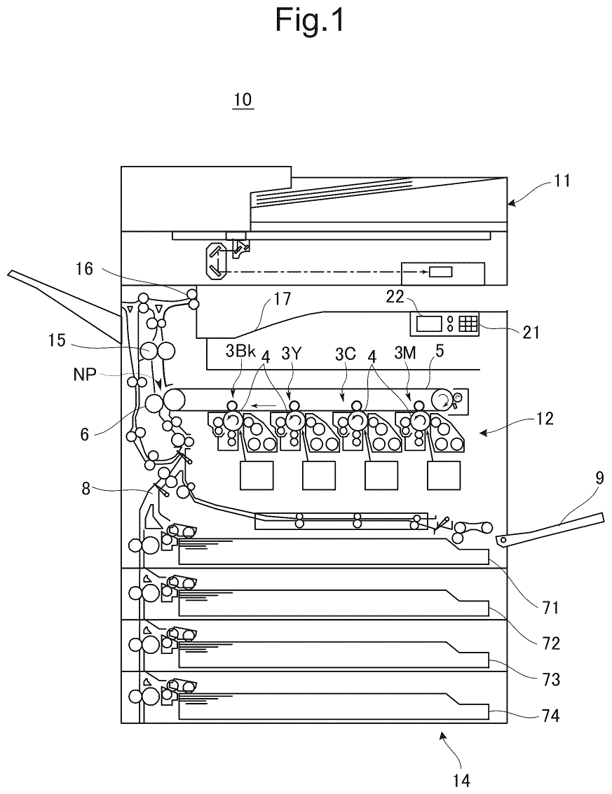

FIG. 1 is a cross-sectional view showing the image forming apparatus according to a first embodiment of the disclosure. As shown in FIG. 1, the image forming apparatus 10 is a multifunction peripheral (MFP) having a plurality of functions, such as copying and scanning. The image forming apparatus 10 includes an image reading device 11 and an image forming device 12.

The image reading device 11 includes an image sensor (e.g., contact image sensor) that optically reads an image on a source document, and image data representing the image of the document is generated from an analog output from the image sensor.

The image forming device 12 serves to print the image represented by the image data, through the electrophotographic process on a recording sheet P, and includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged and exposed, to thereby form an electrostatic latent image on the surface of the photoconductor drum 4, and then the electrostatic latent image on the surface of the photoconductor drum 4 is developed into a toner image, which is transferred to an intermediate transfer belt 5. As result, a colored toner image is formed on the intermediate transfer belt 5. The colored toner image is transferred, as secondary transfer, to the recording sheet P transported from the sheet feeding device 14 along a transport route 8, at a nip region NP between the intermediate transfer belt 5 and a secondary transfer roller 6.

The sheet feeding device 14 includes a first sheet cassette 71, a second sheet cassette 72, a third sheet cassette 73, a fourth sheet cassette 74, and a manual bypass tray 9. The recording sheet P is delivered to the transport route 8, either from one of the sheet cassettes 71 to 74, or from the manual bypass tray 9. After the recording sheet P is transported along the transport route 8, the colored toner image on the intermediate transfer belt 5 is transferred, as the secondary transfer, to the recording sheet P at the nip region NP between the intermediate transfer belt 5 and the secondary transfer roller 6. The sheet cassette exemplifies the sheet supply device in the disclosure.

Thereafter, a fixing device 15 heats and presses the recording sheet P, to fix the toner image onto the recording sheet P, by thermal compression, and then the recording sheet P is delivered to an output tray 17, via a delivery roller 16.

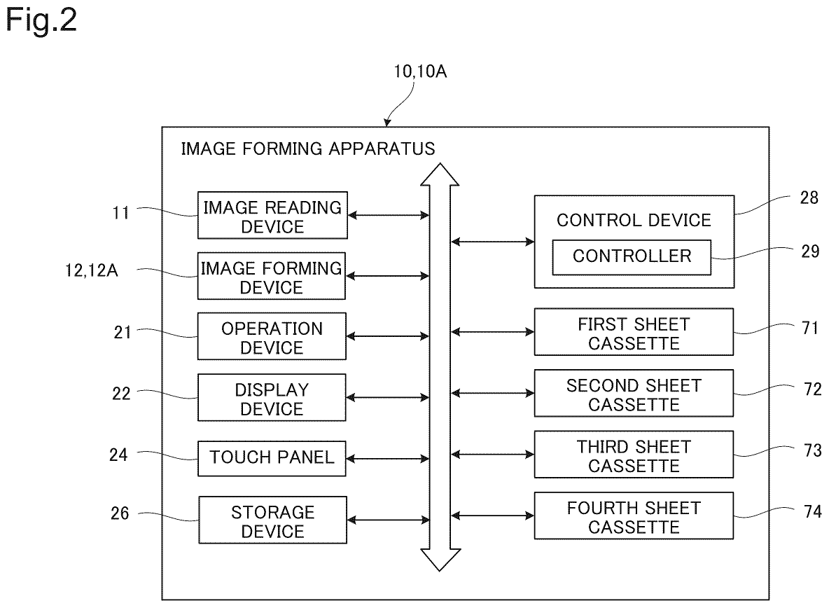

FIG. 2 is a block diagram showing an internal configuration of the image forming apparatus 10. As shown in FIG. 2, the image forming apparatus 10 includes the image reading device 11, the image forming device 12, an operation device 21, a display device 22, a touch panel 24, a storage device 26, sheet cassettes 71 to 74, and a control device 28. The cited components are configured to transmit and receive data and signals to and from each other, via a bus.

The operation device 21 includes physical keys such as a numeric keypad, an enter key, and a start key. The display device 22 is, for example, constituted of a liquid crystal display (LCD) or an organic light-emitting diode (OLED) display.

The touch panel 24 is overlaid on the screen of the display device 22. The touch panel 24 is based on what is known as a resistive film or electrostatic capacitance, and detects a contact (touch) of the user's finger made thereon, along with the touched position, and outputs a detection signal indicating the coordinate of the touched position, to a controller 29 of the control device 28, which will be subsequently described.

The storage device 26 is a large-capacity storage device such as a solid-state drive (SSD) or a hard disk drive (HDD), and contains various application programs and various types of data.

The control device 28 includes a processor, a random-access memory (RAM), a read-only memory (ROM), and so forth. The processor is, for example, a central processing unit (CPU), an application specific integrated circuit (ASIC), or a micro processing unit (MPU). The control device 28 serves as the controller 29, when the processor executes a control program stored in the ROM or the storage device 26.

The controller 29 executes overall control of the image forming apparatus 10. The controller 29 is connected to the image reading device 11, the image forming device 12, the operation device 21, the display device 22, the touch panel 24, the storage device 26, and the sheet cassettes 71 to 74. The controller 29 controls the operation of the components cited above, and transmits and receives signals and data to and from those components.

The controller 29 serves as a processing device that executes various processings necessary for the image forming job by the image forming apparatus 10. The controller 29 accepts instructions to execute the operation, inputted by the user, on the basis of a detection signal outputted from the touch panel 24, or an operation on the physical key of the operation device 21. For example, the controller 29 accepts a user's touch operation made through the touch panel 24, on a graphical user interface (GUI) displayed on the screen of the display device 22. The controller 29 is also configured to control the displaying operation of the display device 22.

Further, the controller 29 controls the respective drive sources (e.g., motor) that operate the sheet cassettes 71 to 74, to thereby cause one of the sheet cassettes 71 to 74 to feed the recording sheet P to the transport route 8.

In the image forming apparatus 10 configured as above, the controller 29 performs a print job, including causing the image reading device 11 to read the image on the document, causing one of the sheet cassettes 71 to 74 of the sheet feeding device 14 to supply the recording sheet, causing the image data representing the document image (exemplifying the print data in the disclosure) to be inputted to the image forming device 12, and causing the image forming device 12 to form the document image on the recording sheet supplied as above.

The controller 29 also counts the number of recording sheets that have undergone the image forming operation by the image forming device 12. Each time the counted number of sheets reaches a predetermined threshold, the controller 29 performs a prespecified image forming operation for adjustment, including causing one of the sheet cassettes 71 to 74 of the sheet feeding device 14 to supply the recording sheet, and causing the image forming device 12 to form a pattern of black, yellow, cyan, and magenta colors on the recording sheet, on the basis of predetermined image data representing the pattern of each of the mentioned colors. Such prespecified image forming operation for adjustment will hereinafter be referred to as adjustment operation.

After the image forming operation for adjustment is performed, for example the maintenance staff of the image forming apparatus 10 visually checks the pattern of each color formed on the recording sheet, and inputs, through the operation device 21, an adjustment amount of density of each color component, in the image to be formed on the recording sheet by the image forming device 12. The controller 29 determines the density of each color component in the image, to be formed on the recording sheet at the time that the image forming device 12 executes the image forming operation, on the basis of the inputted adjustment amount of the density of each color component. Alternatively, the user may cause the image reading device 11 to read the pattern of each color formed on the recording sheet. In this case, the controller 29 decides the density level of the pattern of each color read by the image reading device 11, and determines the density of each color component in the image, to be formed on the recording sheet at the time that the image forming device 12 executes the image forming operation, on the basis of the density of each color component decided as above.

Since the image forming apparatus 10 includes the four sheet cassettes, namely the first sheet cassette 71, the second sheet cassette 72, the third sheet cassette 73, and the fourth sheet cassette 74, the recording sheet to be used for the image forming operation based on the print data, and the recording sheet to be used for the adjustment operation are supplied from different sheet cassettes.

In addition, the adjustment operation includes a plurality of types. Examples of the plurality of types of adjustment operation include a type I and a type II. The adjustment operation of the type I refers to the adjustment operation including matching the size and the layout of the respective patterns of black, yellow, cyan, and magenta colors, to be formed on the recording sheet, to the standard sheet size “A4”. The adjustment operation of the type II refers to the adjustment operation including matching the size and the layout of the pattern of each color to be formed on the recording sheet, to the standard sheet size “A3”. Accordingly, the recording sheet of the standard sheet size “A4”, to be used for the adjustment operation of the type I, is supplied from the sheet cassette designated as the supply source for adjustment operation of the type I, and the recording sheet of the standard sheet size “A3”, to be used for the adjustment operation of the type II, is supplied from the sheet cassette designated as the supply source for adjustment operation of the type II. Here, the controller 29 restricts the sheet cassette designated as the supply source for adjustment operation, from supplying the recording sheet to be used for the image forming operation based on the print data.

The image data representing the pattern of each color that matches the standard sheet size “A4” for the adjustment operation of the type I, and the image data representing the pattern of each color that matches the standard sheet size “A3” for the adjustment operation of the type II, are stored in advance in the storage device 26, to be retrieved therefrom by the controller 29 and utilized for the adjustment operation.

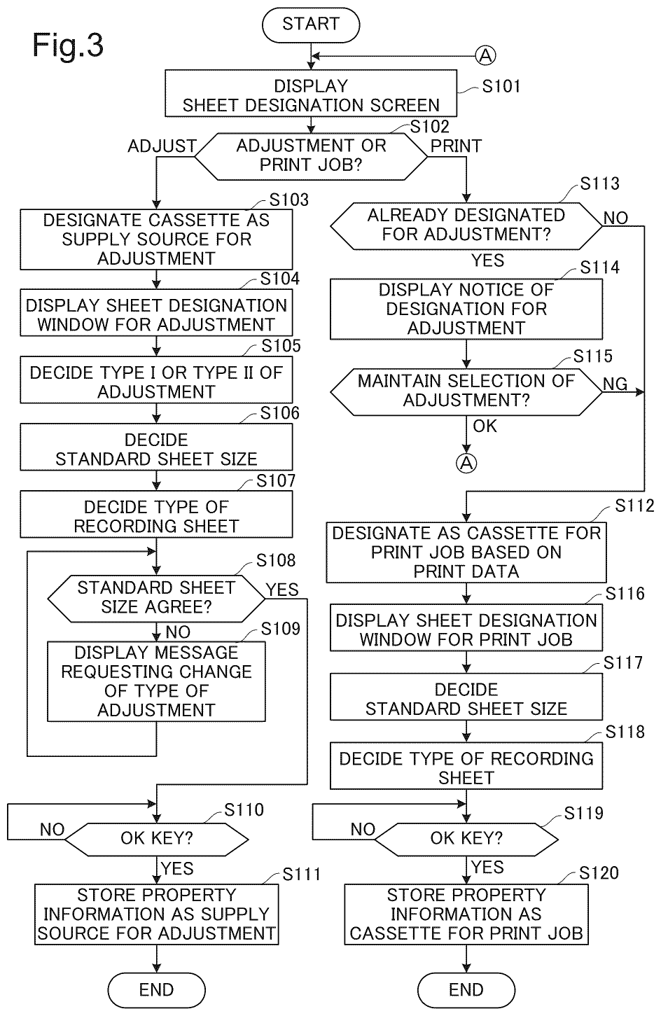

Referring now to a flowchart shown in FIG. 3, a process of designating the sheet cassettes 71 to 74 as the supply source of the recording sheet to be used for the adjustment operation, or the supply source of the recording sheet to be used for the image forming operation based on the print data, will be described hereunder.

Here, it will be assumed that the recording sheets of the respective standard sheet sizes are stored by the user in the sheet cassettes 71 to 74. To be more specific, it will be assumed that the recording sheets of the standard sheet size “A4” are stored in the first sheet cassette 71, the recording sheets of the standard sheet size “A3” are stored in the second sheet cassette 72, the recording sheets of the standard sheet size “A4” are stored in the third sheet cassette 73, and the recording sheets of the standard sheet size “A3” are stored in the fourth sheet cassette 74.

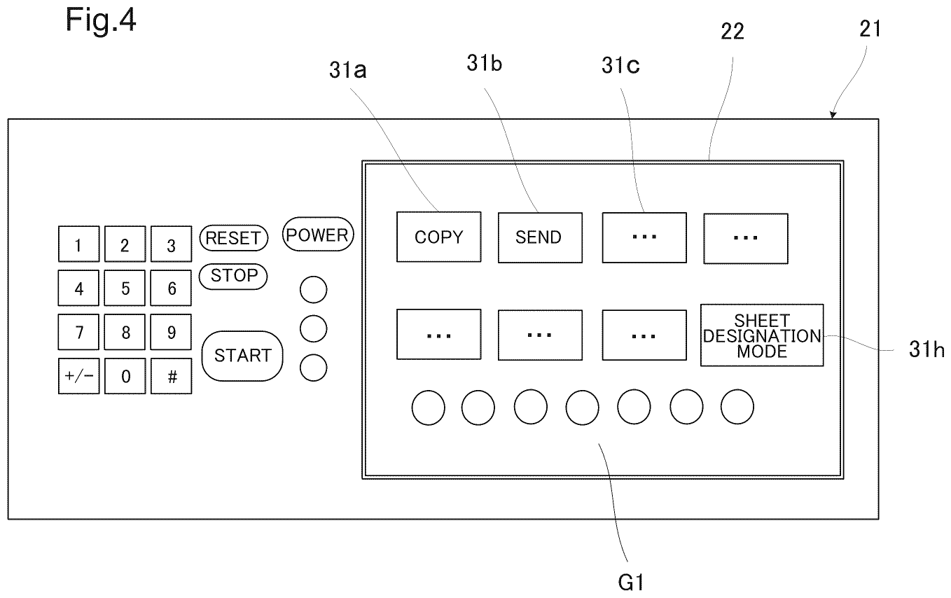

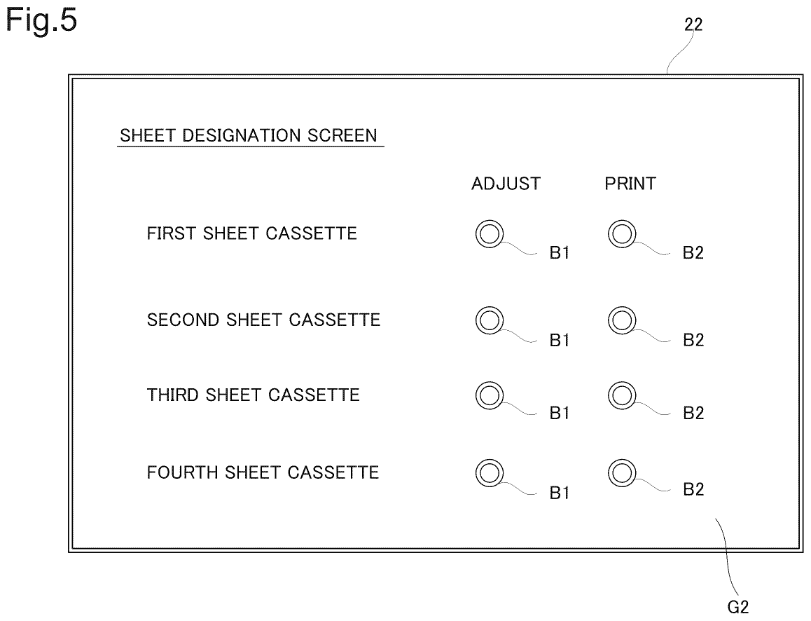

In a standby state of the image forming apparatus 10, for example an initial screen G1 shown in FIG. 4 is displayed on the display device 22, by the controller 29. The initial screen G1 includes a plurality of function keys 31a to 31h, associated with the respectively corresponding functions. When the user touches the function key 31h, associated with a sheet designation mode, the controller 29 receives the instruction associated with the function key 31h, through the touch panel 24, and causes the display device 22 to display a sheet selection screen G2 shown in FIG. 5, according to the instruction received (S101).

The sheet selection screen G2 shown in FIG. 5 includes a button B1 for inputting an instruction to designate the sheet cassette as the supply source of the recording sheet to be used for the adjustment operation, and a button B2 for inputting an instruction to designate the sheet cassette as the supply source of the recording sheet to be used for the image forming operation based on the print data, with respect to each of the first sheet cassette 71, the second sheet cassette 72, the third sheet cassette 73, and the fourth sheet cassette 74.

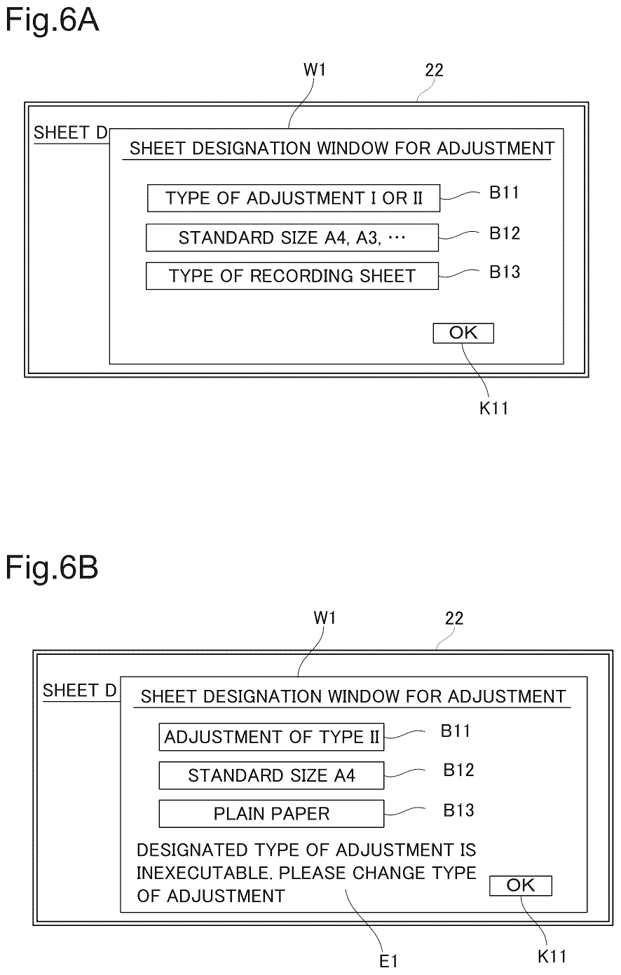

For example, when the user touches the button B1 of the third sheet cassette 73 in the sheet selection screen G2, the controller 29 receives, through the touch panel 24, the instruction to designate the third sheet cassette 73 as the supply source of the recording sheet to be used for the adjustment operation (S102 “Adjust”), as the instruction corresponding to the button B1 of the third sheet cassette 73, and designates the third sheet cassette 73 as the mentioned supply source (S103). At this point, the controller 29 displays a sheet designation window for adjustment operation W1, as the example shown in FIG. 6A (S104).

The sheet designation window for adjustment operation W1 includes a button B11 for inputting an instruction to select the type I or type II of the adjustment operation, a button B12 for inputting an instruction to select the standard sheet size of the recording sheet stored in the third sheet cassette 73, a button B13 for inputting an instruction to select the type of the recording sheet, and an OK key K11.

When the user touches the button B11, a pull-down display instruction is received by the touch panel 24, and the controller 29 displays a pull-down screen indicating the types of the adjustment operation, according to the instruction. When the user touches the region in the pull-down screen indicating the type I or type II of the adjustment operation, the controller 29 receives, through the touch panel 24, the instruction to designate the type of the adjustment operation, displayed in the touched region.

When the user touches the button B12, a pull-down display instruction, for displaying a plurality of standard sheet sizes, is received by the touch panel 24, and the controller 29 displays a pull-down screen indicating the plurality of standard sheet sizes, according to the instruction. When the user touches the region in the pull-down screen indicating one of the standard sheet sizes, the controller 29 receives, through the touch panel 24, the instruction to designate the standard sheet size, displayed in the touched region.

Further, when the user touches the button B13, a pull-down display instruction, for displaying a plurality of types of the recording sheet, is received by the touch panel 24, and the controller 29 displays a pull-down screen indicating the plurality of types of the recording sheet, according to the instruction. When the user touches the region in the pull-down screen indicating one of the types of the recording sheet, the controller 29 receives, through the touch panel 24, the instruction to designate the type of the recording sheet, displayed in the touched region.

After the sheet designation window for adjustment operation W1 is displayed, the controller 29 decides which of the type I and the type II of the adjustment operation has been selected, on the basis of the instructions received as above (S105). In addition, the controller 29 decides which of the standard sheet sizes has been selected (S106), and which of the types of the recording sheet has been selected (S107), on the basis of the instructions received as above.

Further, the controller 29 decides whether the standard sheet size of the recording sheet decided at S106, for example “A4”, accords with the proper standard sheet size of the recording sheet, to be used for the adjustment operation of the type I or type II, decided at S105 (S108). In the controller 29, the proper standard sheet sizes of the recording sheet, to be used for the adjustment operation of the type I and type II, are stored, with respect to each of the types of the adjustment operation.

In the case where the selected standard sheet size discords with the proper standard sheet size (No at S108), the adjustment operation of the type decided at S105 is unable to be executed. Accordingly, upon deciding as above, the controller 29 causes the display device 22 to display a sheet designation window W1, including a message E1 urging the user to change the type of the adjustment operation, as the example shown in FIG. 6B (S109). For example, when the adjustment operation of the type II is selected at S105, and the standard sheet size of the recording sheet to be used for the adjustment operation of the type II is “A3”, while the standard sheet size of the recording sheet stored in the sheet cassette selected at S106, in this example the third sheet cassette 73, is “A4”, the controller 29 decides that the standard sheet size “A4” decided at S106 discords with the standard sheet size “A3” of the recording sheet for the adjustment operation of the type II, decided at S105. Therefore, the message E1 is displayed on the display device 22.

It is assumed here that the user has again touched the button B11, in view of the message E1 displayed on the sheet designation window W1, thereby inputting an instruction to change the adjustment operation of the type II to that of the type I. Upon receipt of such instruction through the touch panel 24, the controller 29 applies the type of the adjustment operation indicated by the instruction, in this case the type I, to the third sheet cassette 73. Accordingly, the proper standard sheet size “A4” for the adjustment operation of the type I, and the standard sheet size “A4” assigned to the third sheet cassette 73, accord with each other.

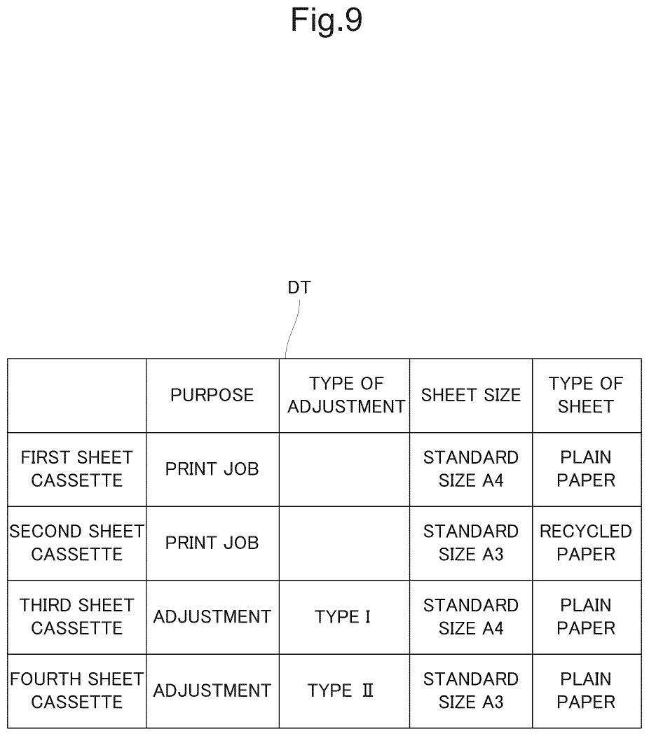

Upon deciding that the standard sheet size of the recording sheet stored in the sheet cassette accords with the standard sheet size of the recording sheet to be used for the adjustment operation of the type I or the type II (“Yes” at S108), the controller 29 decides whether a storage instruction, to store the standard sheet size, the type of the adjustment operation, and the type of the recording sheet that are currently selected as property information of the third sheet cassette 73, has been received (S110). When the user touches the OK key K11, so that the controller 29 receives the storage instruction associated with the OK key K11, through the touch panel 24 (“Yes” at S110), the controller 29 writes the event that the third sheet cassette 73 has been designated as the supply source at S103, the type of the adjustment operation decided at S105, the standard sheet size of the recording sheet decided at S106, and the type of the recording sheet decided at S107, in a data table DT shown in FIG. 9, as the property information of the third sheet cassette 73 (S111). The term “Adjustment” shown in the column of “Purpose” in the data table DT indicates that the corresponding sheet cassette is the supply source for adjustment operation.

In contrast, when the user touches the button B2 of the first sheet cassette 71, while the sheet selection screen G2 shown in FIG. 5 is displayed, the controller 29 receives, through the touch panel 24, an instruction to designate the first sheet cassette 71 as the sheet cassette for printing, as the instruction corresponding to the button B2 of the first sheet cassette 71 (“Print” at S102). The sheet cassette for printing exemplifies the sheet supply device for printing in the disclosure.

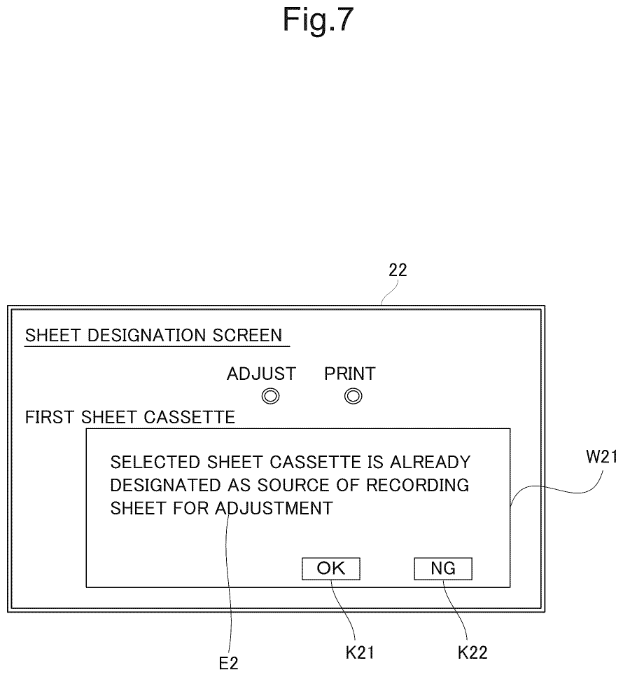

Then the controller 29 looks up the data table DT shown in FIG. 9, to thereby decide whether the first sheet cassette 71 selected at S112 is already designated as the supply source to be used for the adjustment operation (S113). Upon deciding that the first sheet cassette 71 is already designated as the supply source (“Yes” at S113), the controller 29 causes the display device 22 to display a window W21, including a message E2 to the effect that the first sheet cassette 71 is already designated as the supply source to be used for the adjustment operation, an OK key K21, and an NG key K22, as shown in FIG. 7 (S114). The message E2 exemplifies the warning message in the disclosure.

When the user intends, in view of the message E2, to maintain setting of the first sheet cassette 71 as the supply source for adjustment operation, the user touches the OK key K21. Accordingly, the controller 29 receives a confirmation instruction of such setting, corresponding to the OK key K21 (“OK” at S115), through the touch panel 24. The controller 29 maintains the setting of the first sheet cassette 71 as the supply source for adjustment operation, according to the confirmation instruction. Thereafter, the operation returns to S101.

On the contrary, when the user intends to cancel the setting of the first sheet cassette 71 as the supply source for adjustment operation, and designate the first sheet cassette 71 as the sheet cassette for printing, for supplying the recording sheet to be used for the image forming operation based on the print data, the user touches the NG key K22. In this case, the controller 29 receives, through the touch panel 24, a change instruction to designate the first sheet cassette 71 as the sheet cassette for printing (“NG” at S115), associated with the NG key K22. In accordance with such change instruction, the controller 29 cancels the setting of the first sheet cassette 71 as the supply source for adjustment operation, and designates the first sheet cassette 71 as the sheet cassette for printing (S112).

Here, also in the case of deciding that the first sheet cassette 71 is not designated as the supply source for adjustment operation (“No” at S113), the controller 29 designates the first sheet cassette 71 as the sheet cassette for printing, according to the instruction received at S102 (S112).

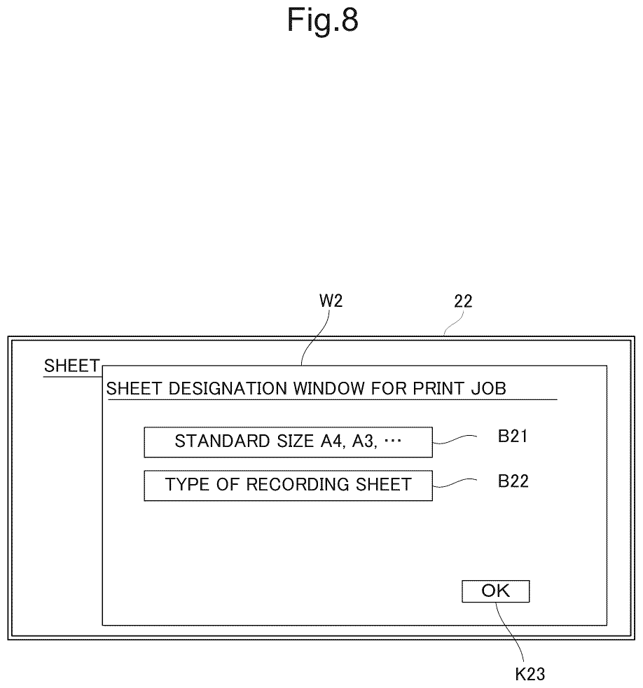

Upon designating the sheet cassette as the sheet cassette for printing as described above (S112), the controller 29 displays a sheet designation window for print job W2, as the example shown in FIG. 8 (S116).

The sheet designation window for print job W2 shown in FIG. 8 includes a button B21 for inputting an instruction to select the sheet cassette designated at S112, in this case the standard sheet size of the recording sheet stored in the first sheet cassette 71, a button B22 for inputting an instruction to select the type of the recording sheet, and an OK key K23.

When the user touches the button B21, the pull-down display instruction, for displaying a plurality of standard sheet sizes, is received by the touch panel 24, and the controller 29 displays the pull-down screen indicating the plurality of standard sheet sizes, according to the instruction. When the user touches the region in the pull-down screen indicating one of the standard sheet sizes, the controller 29 receives, through the touch panel 24, the instruction to designate the standard sheet size, displayed in the touched region.

Further, when the user touches the button B22, the pull-down display instruction, for displaying a plurality of types of the recording sheet, is received by the touch panel 24, and the controller 29 displays the pull-down screen indicating the plurality of types of the recording sheet, according to the instruction. When the user touches the region in the pull-down screen indicating one of the types of the recording sheet, the controller 29 receives, through the touch panel 24, the instruction to designate the type of the recording sheet, displayed in the touched region.

After the sheet designation window for the print job W2 is displayed, the controller 29 decides which of the standard sheet sizes has been selected, on the basis of the instructions received as above (S117), and also decides which of the types of the recording sheet has been selected (S118), on the basis of the instructions received as above.

Thereafter, when the user touches the OK key K23, so that the controller 29 receives the storage instruction associated with the OK key K23, through the touch panel 24 (“Yes” at S119), the controller 29 writes the event that the first sheet cassette 71 has been designated as the sheet cassette for printing at S112, the standard sheet size of the recording sheet decided at S117, and the type of the recording sheet decided at S118, in the data table DT shown in FIG. 9, as the property information of the first sheet cassette 71 (S120). The term “Print Job” shown in the column of “Purpose” in the data table DT indicates that the corresponding sheet cassette is designated as the sheet cassette for printing.

The selection of “Adjust” at S102 and the operations of S103 to S111, or the selection of “Print” at S102 and the operations of S112 to S120, are also executed with respect to the remaining sheet cassettes, namely the second sheet cassette 72 and the fourth sheet cassette 74, so that the sheet cassette is designated either as the supply source for adjustment operation, or as the sheet cassette for printing. When the sheet cassette is designated as the supply source for adjustment operation, the controller 29 writes, in the same way as above, the event that the sheet cassette has been designated as the supply source for adjustment operation, the type of the adjustment operation, the standard sheet size of the recording sheet, and the type of the recording sheet, in the data table DT. When the sheet cassette is designated as the sheet cassette for printing, the controller 29 writes the event that the sheet cassette has been designated as the sheet cassette for printing, the standard sheet size of the recording sheet, and the type of the recording sheet, in the data table DT.

In the data table DT shown in FIG. 9, the first sheet cassette 71 is specified as being the sheet cassette for printing, containing the recording sheet of the standard sheet size “A4”, and containing the recording sheet of the “Plain Paper”. The second sheet cassette 72 is specified as being the sheet cassette for printing, containing the recording sheet of the standard sheet size “A3”, and containing the recording sheet of the “Recycled Paper”. The third sheet cassette 73 is specified as being the supply source for adjustment operation, being prepared for the adjustment operation of the type I, containing the recording sheet of the standard sheet size “A4”, and containing the recording sheet of the “Plain Paper”. The fourth sheet cassette 74 is specified as being the supply source for adjustment operation, being prepared for the adjustment operation of the type II, containing the recording sheet of the standard sheet size “A3”, and containing the recording sheet of the “Plain Paper”.

Being the sheet cassette for printing, being the supply source for adjustment operation, the type of the adjustment operation, the standard sheet size of the recording sheet, and the type of the recording sheet, specified in the data table DT, exemplify the property information in the disclosure.

When the property information of the sheet cassettes is thus written in the data table DT, with respect to each of the sheet cassettes 71 to 74, the operation according to the flowchart shown in FIG. 3 is finished.

In this embodiment, the standard sheet size of the recording sheet stored in each of the sheet cassettes 71 to 74 is inputted, through the sheet designation window W1 or W2. Alternatively, a sensor for detecting the standard sheet size of the recording sheet may be provided on each of the sheet cassettes 71 to 74, so that the controller 29 adopts the standard sheet sizes of the recording sheet, detected by the sensors, as the property information of the respective sheet cassettes.

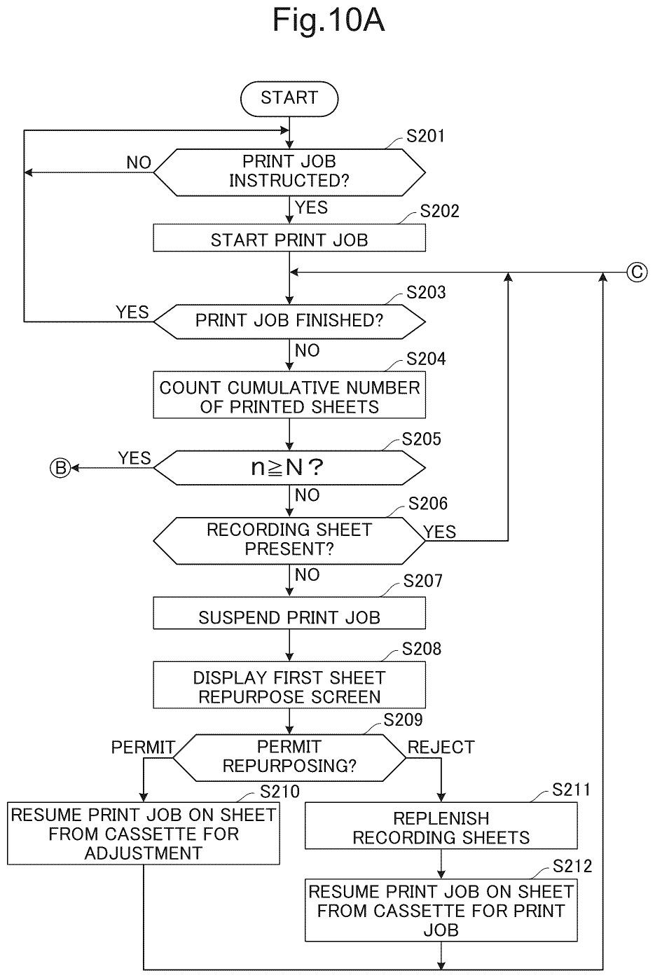

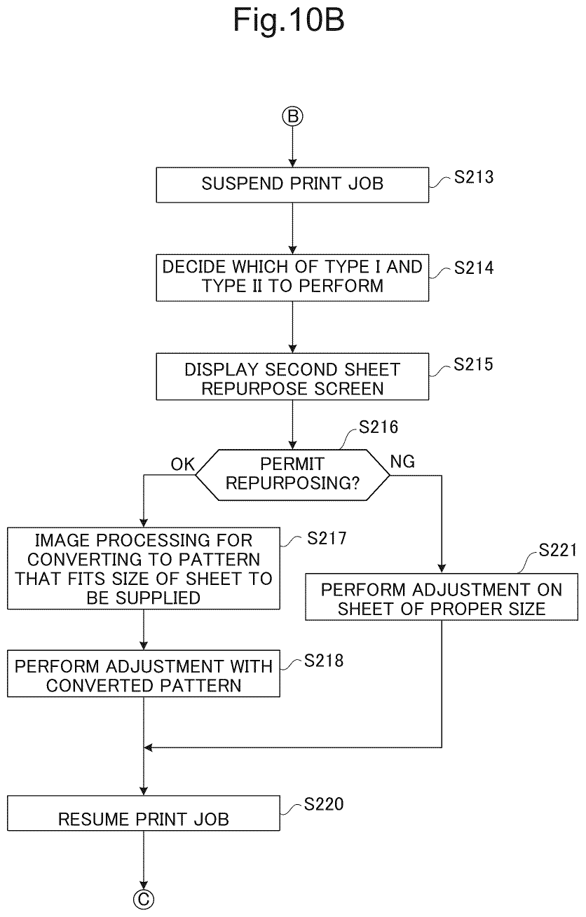

Referring now to the flowcharts shown in FIG. 10A and FIG. 10B, a process of selecting one of the sheet cassettes 71 to 74, and supplying the recording sheet from the selected sheet cassette, will be described hereunder.

It will be assumed, for example, that the user has set a document on the image reading device 11, and inputted, through the operation device 21, an instruction to designate the standard sheet size “A4” of the recording sheet, and an instruction to execute a copying operation.

The controller 29 accepts the print job, on the basis of the instruction to execute the copying operation, inputted to the operation device 21. Upon accepting the print job (“Yes” at S201), the controller 29 causes the image reading device 11 to read the image of the document, and looks up the data table DT, thereby selecting the sheet cassette designated as the sheet cassette for printing, and specified as containing the recording sheet of the standard sheet size “A4”. In this example, the controller 29 selects the first sheet cassette 71, as the sheet cassette satisfying the mentioned condition. The controller 29 causes the first sheet cassette 71 selected, to supply the recording sheet of the standard sheet size “A4”, and causes the image forming device 12 to form the image of the document, represented by the image print data, on the recording sheet of the standard sheet size “A4” (S202).

In the case where a plurality of documents are set on the image reading device 11, controller 29 causes the image reading device 11 to sequentially read the image of each document, causes the first sheet cassette 71 to sequentially supply the recording sheets of the standard sheet size “A4”, and causes the image forming device 12 to form the images of the documents on the respective recording sheets of the standard sheet size “A4”.

During the execution of the print job (“No” at S203), the controller 29 counts up, each time the image forming operation on a recording sheet is finished, the cumulative number n of recording sheets that have undergone the image forming operation (including the cumulative number of the recording sheets involved in other types of job finished earlier) (S204), and decides whether the cumulative number n has reached a predetermined threshold N (S205). In the case where the cumulative number n has not reached the threshold N (“No” at S205), the controller 29 decides whether there are any recording sheets in the first sheet cassette 71, according to a detection output from a non-illustrated recording sheet sensor provided on the first sheet cassette 71 (S206). Upon deciding that the recording sheets are present in the first sheet cassette 71, (“Yes” at S206), the controller 29 repeats the operation of S203 to S206, and returns to S201, upon finishing the print job (“Yes” at S203). Thereafter, the controller 29 stands by for the next print job.

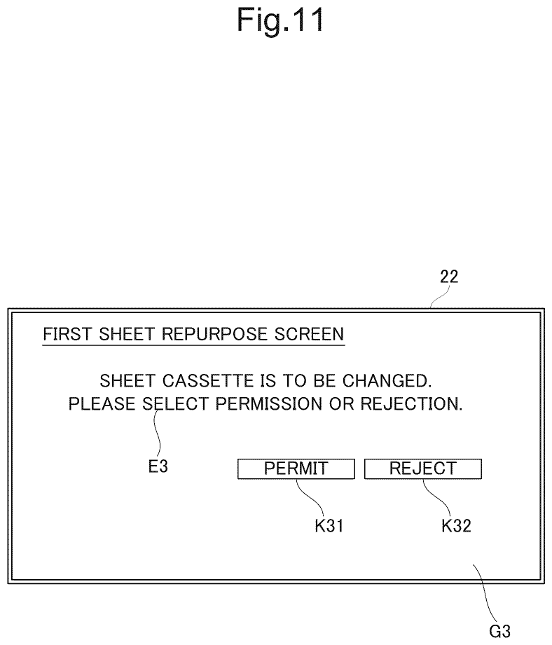

In contrast, upon deciding that the recording sheets in the first sheet cassette 71 have run out (“No” at S206), before the cumulative number n reaches the threshold N (“No” at S205), the controller 29 suspends the print job (S207). Then the controller 29 looks up the data table DT, thereby detecting the sheet cassette specified as containing the recording sheet of the standard sheet size “A4”, in this case the third sheet cassette 73 designated as the supply source for adjustment operation, and displays a first sheet repurpose screen G3 (see FIG. 11), for selecting whether to permit or reject the supply of the recording sheet from the third sheet cassette 73, to continue with the print job (S208). The first sheet repurpose screen G3 includes a message E3 requesting to permit or reject the repurposing of the sheet cassette designated as the supply source for adjustment operation, as the sheet cassette for printing, a permission key K31 for inputting the permission, and a rejection key K32 for inputting the rejection.

In view of the message E3, the user decides whether to permit or reject the repurposing of the third sheet cassette 73 as the supply source of the recording sheet for the print job, and touches one of the permission key K31 and the rejection key K32.

Upon receipt of the permission instruction associated with the permission key K31, through the touch panel 24 (“Permit” at S209), the controller 29 resumes the print job, by causing the third sheet cassette 73, designated as the supply source for adjustment operation to supply the recording sheet of the standard sheet size “A4”, and causing the image forming device 12 to form the image of the document on the recording sheet of the standard sheet size “A4” (S210), and repeats the operation as from S203.

In contrast, upon receipt of the rejection instruction associated with the rejection key K32, through the touch panel 24 (“Reject” at S209), the controller 29 causes the display device 22 to display a message urging the user to replenish the recording sheets of the standard sheet size “A4” in the first sheet cassette 71 (S211).

In view of the message displayed at S211, the user replenishes the recording sheets of the standard sheet size “A4” in the first sheet cassette 71. The controller 29 then decides that the recording sheets are present in the first sheet cassette 71, on the basis of the detection output from the recording sheet sensor, and resumes the print job, by causing the first sheet cassette 71 to supply the recording sheet of the standard sheet size “A4”, and causing the image forming device 12 to form the image of the document on the recording sheet (S212), and repeats the operation as from S203.

Thus, the recording sheets of the standard sheet size “A4” are supplied from the first sheet cassette 71, and the cumulative number n of the recording sheets is counted up. When the first sheet cassette 71 becomes empty, either the recording sheets of the standard sheet size “A4” are supplied from the third sheet cassette 73, designated as the supply source for adjustment operation, instead of the first sheet cassette 71, or the recording sheets are replenished in the first sheet cassette 71, so that the supply of the recording sheets of the standard sheet size “A4” from the first sheet cassette 71 is resumed, and the counting up of the cumulative number n of the recording sheets is continued.

Now, upon deciding at S205 that the cumulative number n has reached the threshold N (“Yes” at S205), the controller 29 suspends the print job (S213). This is because the timing that the cumulative number n has reached the threshold N is scheduled as the timing to execute the adjustment operation. The controller 29 decides which of the adjustment operation of the type I and the type II is to be executed (S214). Which of the adjustment operation of the type I and the type II is to be executed is prespecified depending on the usage status of the image forming apparatus 10 (e.g., frequency of use of each standard sheet size), and stored in the controller 29. For example, when the adjustment operation of the type II is scheduled in advance, the controller 29 decides that the adjustment operation of the type II is to be executed (S214). As described above, the adjustment operation of the type II refers to the adjustment operation including matching the size and the layout of the pattern of each color to be formed on the recording sheet for adjustment, to the standard sheet size “A3”.

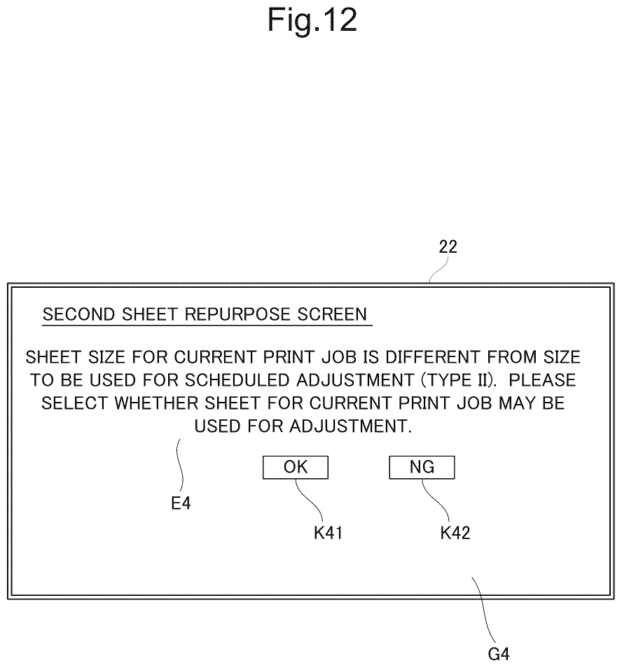

The controller 29 causes the display device 22 to display a second sheet repurpose screen G4 (see FIG. 12), for inputting an instruction to select whether to repurpose the recording sheets of the standard sheet size “A4”, supplied from the first sheet cassette 71 which is the sheet cassette for the print job suspended at S213, as the recording sheet for the adjustment operation (in this case, type II) (S215). The second sheet repurpose screen G4 includes a message E4 requesting to determine whether the recording sheets of the standard sheet size “A4” currently used for the printing operation based on the print data may be used for the adjustment operation, in other words whether the recording sheets currently used for the printing operation, having the size different from the size that the recording sheet for the adjustment operation of the type II is supposed to have, may be used for the adjustment operation of the type II, an OK key K41 for inputting the permission, and an NG key K42 for inputting the rejection.

For example, when the user intends to use the recording sheets of the standard sheet size “A4” being supplied for the print job for the adjustment operation, in view of the message E4, the user touches the OK key 41. The controller 29 receives the permission instruction associated with the OK key 41, through the touch panel 24 (“OK” at S216), retrieves the image of the pattern of each color that matches the standard sheet size “A3” for the adjustment operation of the type II, from the storage device 26, and performs image processing to arrange the image of the pattern of each color so as to fit the recording sheet of the standard sheet size “A4” supplied from the first sheet cassette 71 (S217). For example, the controller 29 scales down the pattern of each color fitting the standard sheet size “A3”, to the pattern that fits the standard sheet size “A4”.

Thereafter, the controller 29 performs the adjustment operation, by causing the first sheet cassette 71 to supply the recording sheet of the standard sheet size “A4”, and causing the image forming device 12 to form the pattern of each color scaled down so as to fit the standard sheet size “A4”, on the recording sheet of the standard sheet size “A4” (S218).

The recording sheet of the standard sheet size “A4”, on which the pattern of each color has been formed as above, is utilized for the adjustment of density of each color component in the image to be formed on the recording sheet by the image forming device 12.

After the mentioned adjustment operation, the controller 29 resumes the print job which has been suspended (S220). Then, the operation returns to S203.

In contrast, when the user selects, in view of the message E4, not to use the recording sheet of the standard sheet size “A4”, being supplied for the print job, for the adjustment operation of the type II, the user touches the NG key 42. Upon receipt of the rejection instruction associated with the NG key 42, through the touch panel 24 (“NG” at S216), the controller 29 looks up the data table DT, and selects the sheet cassette, designated as the sheet cassette for printing or the supply source for adjustment operation, and specified as containing the recording sheet of the size appropriate for the adjustment operation of the type II, in other words the standard sheet size “A3”, which is the fourth sheet cassette 74 in this example. The controller 29 causes the fourth sheet cassette 74 to supply the recording sheet of the standard sheet size “A3”, retrieves the pattern of each color that fits the standard sheet size “A3” for the adjustment operation of the type II, from the storage device 26, and causes the image forming device 12 to form the pattern of each color on the recording sheet of the standard sheet size “A3” (S221). Thereafter, the operation proceeds to S220.

The recording sheet of the standard sheet size “A3”, on which the pattern of each color has been formed is, as mentioned above, utilized for the adjustment of density of each color component in the image to be formed on the recording sheet by the image forming device 12.

The controller 29 is configured to perform the operation of S217 and S218, upon receipt of the permission instruction associated with the OK key 41, through the touch panel 24 at S216. Alternatively, the step S216 for requesting the user to select whether to permit may be excluded, and the permission for using the recording sheet of the standard sheet size “A4” being supplied for the print job (recording sheet supplied from the sheet cassette for printing) for the adjustment operation may be stored in advance in the controller 29, so that the operation of S217 and the subsequent steps can be performed, immediately after S214.

The mentioned arrangement of continuing to use the recording sheet from the sheet cassette for printing, being currently used, when the timing for executing the adjustment operation is reached, is advantageous because loss of time for switching the sheet cassettes, to supply the appropriate recording sheet, can be minimized. In the case where the sheet cassette for the print job is switched to the sheet cassette designated as supply source for adjustment operation, when the timing for executing the adjustment operation is reached, it takes time to switch the sheet cassettes. Besides, it also takes time to switch, after the adjustment operation is finished, the sheet cassette designated as the supply source for adjustment operation to the sheet cassette that supplies the recording sheet for the print job, which was used before the adjustment operation.

As described above, the image forming apparatus 10 according to the first embodiment is configured to appropriately use the sheet cassettes 71 to 74, according to the designation by the user, as the sheet cassette for supplying the recording sheet for the image forming operation based on the print data, or as the sheet cassette designated as the supply source for adjustment operation. Therefore, the image forming apparatus 10 according to the first embodiment allows the user to optionally designate the sheet cassette that serves as the supply source of the recording sheet to be used for the adjustment operation, which is the image forming operation prespecified for the purpose of adjustment.

### Second Embodiment

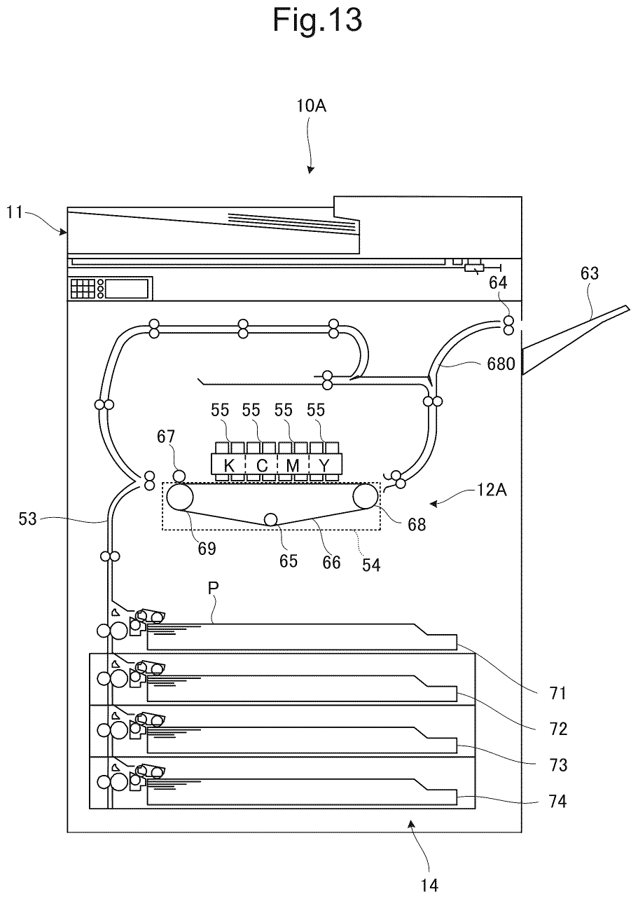

FIG. 13 is a cross-sectional view showing an image forming operation according to a second embodiment of the disclosure. In FIG. 13, the elements that work similarly to those of FIG. 1 are given the same numeral.

The image forming apparatus 10A according to the second embodiment is configured to form an image through an ink jet process, unlike the image forming apparatus 10 according to the first embodiment, which is configured to perform the electrophotographic image forming operation. The image forming apparatus 10A according to the second embodiment includes the image reading device 11 and an image forming device 12A. The image reading device 11 includes an image sensor that optically reads an image on a document, and the image data representing the image of the document is generated from an analog output from the image sensor.

The image forming device 12A forms the image represented by the image data, on the recording sheet P through the ink jet process, and includes line heads 55 that respectively eject ink of four colors, namely black, cyan, magenta, and yellow. The line heads 55 each eject the ink droplets of the corresponding color onto the recording sheet P, delivered to a conveying unit 54 from the sheet feeding device 14 through a transport route 53, thereby forming a color image on the recording sheet P.

The conveying unit 54 includes a drive roller 68, a follower roller 69, a tension roller 65, and a transport belt 66. The transport belt 66 is an endless belt stretched around the drive roller 68, the follower roller 69, and the tension roller 65. The drive roller 68 is driven by a non-illustrated motor so as to rotate clockwise. When the drive roller 68 is made to rotate, the transport belt 66 revolves clockwise, and the follower roller 69 and the tension roller 65 are each passively made to rotate clockwise, by the transport belt 66.

The tension roller 65 serves to maintain the tension of the transport belt 66 at an appropriate level. The transport belt 66 is in contact with an adsorption roller 67, which electrically charges the transport belt 66, to thereby electrostatically adsorb the recording sheet P delivered from the sheet feeding device 14, to the transport belt 66.

The recording sheet P, having the image formed thereon by the image forming device 12A, is delivered to an output tray 63, via an intermediate transport route 680 and a delivery roller 64.

The sheet feeding device 14 includes the first sheet cassette 71, the second sheet cassette 72, the third sheet cassette 73, and the fourth sheet cassette 74, and the recording sheet P is delivered to the transport route 53, from one of the sheet cassettes 71 to 74.

The control system of the image forming apparatus 10A according to the second embodiment is generally the same as that of the image forming apparatus 10 according to the first embodiment shown in FIG. 2. However, since the image forming apparatus 10A according to the second embodiment includes an image forming device 12A based on the ink jet process, in place of the image forming device 12 based on the electrophotography, the controller 29 controls the image forming device 12A based on the ink jet process, to thereby cause the image forming device 12A to form the image of the document on the recording sheet P, through the foregoing method.

The controller 29 also counts the number of recording sheets that have undergone the image forming operation by the image forming device 12A. Each time the counted number of recording sheets reaches a predetermined threshold, the controller 29 performs the adjustment operation including spitting the ink onto the recording sheet, through the line heads 55 of the image forming device 12A. The ink spitting operation is performed to prevent clogging of the nozzles of the line heads 55.

Since the image forming apparatus 10A according to the second embodiment also includes four sheet cassettes, namely the first sheet cassette 71, the second sheet cassette 72, the third sheet cassette 73, and the fourth sheet cassette 74, the recording sheet to be used for the image forming operation based on the print data, and the recording sheet to be used for the adjustment operation are supplied from different sheet cassettes.

The image forming apparatus 10A is also configured to perform the adjustment operation of the type I and the type II. The adjustment operation of the type I performed by the image forming apparatus 10A refers to spitting the ink through the line heads 55 of the image forming device 12A, so as to fit the recording sheet of the standard sheet size “A4”. The adjustment operation of the type II refers to spitting the ink through the line heads 55 of the image forming device 12A, so as to fit the recording sheet of the standard sheet size “A3”.

The spitting pattern of the adjustment operation of the type I, formed through the line heads 55, which fits the standard sheet size “A4”, and the spitting pattern of the adjustment operation of the type II, formed through the line heads 55, which fits the standard sheet size “A3” are stored in advance in the storage device 26, to be retrieved therefrom by the controller 29 and used for the adjustment operation.

Thus, although the image forming apparatus 10A according to the second embodiment is different from the image forming apparatus 10 according to the first embodiment, in including the image forming device 12A based on the ink jet process, in place of the image forming device 12 based on the electrophotography, the image forming apparatus 10A is also configured, like the image forming apparatus 10, to supply the recording sheet for the adjustment operation from a desired one of the sheet cassettes 71 to 74, perform the adjustment operation of the type I so as to fit the standard sheet size “A4”, and perform the adjustment operation of the type II so as to fit the standard sheet size “A3”.

Accordingly, in the image forming apparatus 10A also, the controller 29 makes up the data table DT, by writing therein the property information of the sheet cassette, with respect to each of the sheet cassettes 71 to 74, through the same procedure as the flowchart shown in FIG. 3. Then the controller 29 causes one of the sheet cassettes 71 to 74 to supply the recording sheet, to perform the image forming operation based on the print data, or perform the adjustment operation, through the same procedure as the flowchart shown in FIG. 9.

Therefore, the image forming apparatus 10A according to the second embodiment is, like the image forming apparatus 10 according to the first embodiment, also configured to appropriately use the sheet cassettes 71 to 74, according to the designation by the user, as the sheet cassette for supplying the recording sheet for the image forming operation based on the print data, or as the sheet cassette designated as the supply source for adjustment operation. Therefore, the image forming apparatus 10A according to the second embodiment also allows the user to optionally designate the sheet cassette that serves as the supply source of the recording sheet to be used for the adjustment operation, which is the image forming operation prespecified for the purpose of adjustment.

Here, according to the foregoing embodiments, in the case of repurposing the recording sheet of the standard sheet size “A4”, thus far supplied from the first sheet cassette 71 for the image forming operation based on the print data, as the recording sheet for the adjustment operation, the image of the pattern of each color that fits the standard sheet size “A3” for the adjustment operation of the type II is retrieved from the storage device 26, to be subjected to the image processing, through which the pattern of each color that fits the standard sheet size “A3” is converted so as to fit the standard sheet size “A4”, supplied from the first sheet cassette 71, and the pattern of each color thus converted is formed on the recording sheet of the standard sheet size “A4”, by the image forming device 12 or 12A. Alternatively, the adjustment operation of the type II may be changed to the type I, which is designed for the standard sheet size “A4”, in accordance with the recording sheet of the standard sheet size “A4” currently supplied from the first sheet cassette 71, and the pattern of each color that fits the standard sheet size “A4” for the adjustment operation of the type I, changed from the type II, may be retrieved from the storage device 26, to be formed on the recording sheet of the standard sheet size “A4” by the image forming device 12 or 12A.

When the controller 29 is about to perform the adjustment operation of the type II, upon deciding that the cumulative number n has reached the predetermined threshold N (“Yes” at S205), halfway of the print job in which a plurality of recording sheets of the standard sheet size “A4” are supplied from the first sheet cassette 71 to the image forming device 12 or 12A, and the images based on the print data are formed on the respective recording sheets, the controller 29 may suspend the print job, and rewrite the property information of the first sheet cassette 71 in the data table DT, from the original property information indicating the standard sheet size “A4”, to the property information indicating the standard sheet size “A3”, to be used for the adjustment operation of the type II, in association with the first sheet cassette 71. In this case, when the user sets the recording sheets of the standard sheet size “A3” in the first sheet cassette 71, after such rewriting, the recording sheets of the standard sheet size “A3”, appropriate for the adjustment operation of the type II, can be supplied from the first sheet cassette 71 to the image forming device 12 or 12A, so that the image forming device 12 or 12A performs the adjustment operation of the type II, on the recording sheet of the standard sheet size “A3”. Therefore, the user can perform the adjustment operation of the type II, simply by setting the recording sheets of the standard sheet size “A3” in the first sheet cassette 71, without the need to rewrite him/herself the property information associated with the first sheet cassette 71.

Further, after the adjustment operation of the type II is performed as above, the controller 29 rewrites the property information of the first sheet cassette 71 in the data table DT, to the original property information indicating the recording sheet of the standard sheet size “A4”. When the user again sets the recording sheets of the standard sheet size “A4” in the first sheet cassette 71, after such rewriting, the image forming operation based on the print data can be executed as thus far, on the recording sheet of the standard sheet size “A4”, without need to rewrite him/herself the property information to the original information.

When the adjustment operation is performed by an existing image forming operation, different from the one according to the foregoing embodiments, a sheet supply device storing therein the recording sheet of the type and size appropriate for the adjustment operation is selected out of a plurality of sheet supply devices (e.g., sheet cassettes), and the recording sheet is supplied from the selected sheet supply device. The selection of the sheet supply device is performed on the side of the apparatus, not by the user. Accordingly, the user is unable to optionally designate the sheet supply device that supplies the recording sheet to be used for the adjustment operation, and the recording sheet for the adjustment operation may be supplied from any of the plurality of sheet supply devices, depending on the selection made by the apparatus.

In addition, the aforementioned existing recording apparatus is configured to decide the recording medium on which a test pattern is to be recorded, on the basis of the priority order of the size of the recording medium, and of the type thereof, and supply the recording medium from the cassette containing the recording medium that has been decided. Therefore, the recording medium may be supplied from the sheet cassette unintended by the user.

In contrast, according to the foregoing embodiments, the user can optionally designate the sheet supply device as the supply source of the recording sheet to be used for the adjustment operation, which is the image forming operation prespecified for the purpose of adjustment.

Further, the configurations and processings described in the foregoing embodiments with reference to FIG. 1 to FIG. 13 are merely exemplary, and in no way intended to limit the disclosure to those configurations and processings.

While the present disclosure has been described in detail with reference to the embodiments thereof, it would be apparent to those skilled in the art that the various changes and modifications may be made therein within the scope defined by the appended claims.

What is claimed is:

1. An image forming operation comprising:
a plurality of sheet supply devices that each supply a recording sheet;
an image forming device that executes an image forming operation on a basis of print data, on the recording sheet supplied from one of the sheet supply devices, or an adjustment operation including a prespecified image forming operation for adjustment;
an operation device that receives an instruction, inputted by a user and designating one of the plurality of sheet supply devices, as a supply source of the recording sheet for the adjustment operation; and
a control device including a processor, and configured to act, when the processor executes a control program, as a controller that decides whether the sheet supply device is to be used as the supply source of the recording sheet for the adjustment operation, with respect to each of the sheet supply devices, according to the instruction inputted to the operation device,
wherein, when causing the image forming device to execute the adjustment operation, the controller causes the sheet supply device, designated as the supply source of the recording sheet for the adjustment operation, to supply the recording sheet to the image forming device.

2. The image forming operation according to claim 1,
wherein a designation instruction for designating, out of the plurality of sheet supply devices, the sheet supply device for printing that supplies the recording sheet used for the image forming operation based on the print data, is inputted by the user to the operation device, and
the controller is configured to:
decide whether to designate as the sheet supply device for printing, with respect to each of the sheet supply device, according to the designation instruction inputted to the operation device;
specify property information indicating a sheet size, with respect to the plurality of sheet supply devices;
cause the sheet supply device for printing, for which the property information indicating the sheet size appropriate for the image forming operation based on the print data is specified, to supply the recording sheet to the image forming device, when causing the image forming device to execute the image forming operation based on the print data; and
cause the sheet supply device designated as the supply source to supply the recording sheet to the image forming device, when causing the image forming device to execute the adjustment operation, and cause the image forming device to execute the adjustment operation, in a form that fits the sheet size indicated by the property information.

3. The image forming operation according to claim 2,
wherein the controller is configured to:
cause the sheet supply device for printing to continue to supply the recording sheet to the image forming device, when causing the image forming device to execute the adjustment operation, halfway of the image forming operation based on the print data by the image forming device, in which the recording sheet is supplied from the sheet supply device for printing to the image forming device; and
cause the image forming device, when the sheet size indicated by the property information specified for the sheet supply device for printing is different from the sheet size appropriate for the adjustment operation, to execute the adjustment operation, in a form that fits the sheet size indicated by the property information.

4. The image forming operation according to claim 2,
wherein the controller changes, when causing the image forming device to execute the adjustment operation that fits a predetermined sheet size, halfway of the image forming operation based on the print data by the image forming device, in which the recording sheet is supplied from the sheet supply device for printing to the image forming device, the property information specified for the sheet supply device for printing, which has thus far been supplying the recording sheet for the image forming operation based on the print data, to the property information indicating the predetermined sheet size.

5. The image forming operation according to claim 4,
wherein the controller causes the sheet supply device for printing to supply the recording sheet to the image forming device, after changing the property information specified for the sheet supply device for printing, which was supplying the recording sheet for the image forming operation based on the print data, to the property information indicating the predetermined sheet size, and causes the image forming device to execute the adjustment operation that fits the predetermined sheet size.

6. The image forming operation according to claim 2,
wherein the property information indicating the sheet size is inputted to the operation device, with respect to each of the plurality of sheet supply devices, and
the controller specifies the property information inputted to the operation device, with respect to each of the plurality of sheet supply devices.

7. The image forming operation according to claim 6, further comprising a display device,
wherein the controller causes the display device, upon deciding that the adjustment operation is unable to be executed in a form that fits the sheet size indicated by the property information, to display a message notifying that the adjustment operation is unable to be executed.

8. The image forming operation according to claim 6, further comprising a display device,
wherein the controller is configured to:
specify the property information inputted to the operation device, with respect to each of the sheet supply devices, upon deciding that the adjustment operation can be executed in the form that fits the sheet size indicated by the property information;
cause the display device, upon deciding that the adjustment operation is unable to be executed in the form that fits the sheet size indicated by the property information, to display a message requesting to change the type of the adjustment operation;
decide, when an instruction to change the type of the adjustment operation is inputted to the operation device, after the message is displayed on the display device, whether the adjustment operation, the type of which has been changed according to the instruction inputted, can be executed in the form that fits the sheet size indicated by the property information; and
specify the property information inputted to the operation device, with respect to each of the sheet supply devices, upon deciding that the adjustment operation, the type of which has been changed, can be executed in the form that fits the sheet size indicated by the property information.

9. The image forming operation according to claim 6, further comprising a display device,
wherein the controller causes the display device to display a warning message, when the sheet supply device designated as the supply source is to be changed to the sheet supply device for printing, according to an instruction inputted to the operation device.

10. The image forming operation according to claim 1,
wherein the controller decides, according to an instruction inputted to the operation device, whether to permit or reject the image forming operation based on the print data by the image forming device, to be performed on the recording sheet supplied from the sheet supply device designated as the supply source, and permits or rejects the image forming operation, according to a decision made.

11. The image forming operation according to claim 1,
wherein the controller causes the image forming device to execute a plurality of types of the adjustment operation,
an instruction to designate the sheet supply device as the supply source is inputted to the operation device, with respect to each of the plurality of types of adjustment operation, and
the controller is further configured to:
designate the sheet supply device as the supply source, with respect to each of the plurality of types of adjustment operation, according to the instruction inputted to the operation device; and
cause, when executing one of the plurality of types of adjustment operation, the sheet supply device designated as the supply source for the adjustment operation to be executed, to supply the recording sheet to the image forming device.

12. The image forming operation according to claim 1,
wherein the image forming device forms an image on the recording sheet through an electrophotographic process, and
the adjustment operation includes causing the image forming device to form a predetermined pattern on the recording sheet.

13. The image forming operation according to claim 1,
wherein the image forming device forms an image on the recording sheet through an ink jet process, and
the adjustment operation includes causing the image forming device to spit ink onto the recording sheet.
